(19) United States
(12) Patent Application Publication
(10) Pub. No.: US 2026/0233385 A1
(43) Pub. Date: Aug. 13, 2026

(54) ARTICULABLE INVERTING AND EVERTING ROBOTIC LIMBS

(71) Applicants: Massachusetts Institute of Technology, Cambridge, MA (US); The Board of Trustees of the Leland Stanford Junior University, Stanford, CA (US)

(72) Inventors: Kentaro Barhydt, Cambridge, MA (US); Obumneme Godson Osele, Stanford, CA (US); Allison Okamura, Mountain View, CA (US); Haruhiko Harry Asada, Lincoln, MA (US)

(73) Assignees: Massachusetts Institute of Technology, Cambridge, MA (US); The Board of Trustees of the Leland Stanford Junior University, Stanford, CA (US)

(21) Appl. No.: 19/160,021

(22) PCT Filed: Mar. 29, 2024
(86) PCT No.: PCT/US2024/022241

§ 371 Date: Aug. 26, 2025

Related U.S. Application Data
(60) Provisional application No. 63/493,386, filed on Mar. 31, 2023.

(51) Int. Cl. B25J 9/14; A61G 7/10; B25J 9/10; B25J 18/02; B25J 18/06

(52) U.S. Cl. CPC B25J 9/142; A61G 7/1021; B25J 9/104; B25J 18/02; B25J 18/06

(57) ABSTRACT

Segmented flexible robotic limbs with low bending stiffnesses and high compressive stiffnesses are disclosed. The 2024/206829 disclosed flexible robotic limbs may include inverting/everting flexible inflatable structures that include a plurality of serially arranged interconnected chambers that include connections between adjacent interconnected chambers. The connections fluidly coupling adjacent interconnected chambers may have smaller transverse cross sectional areas perpendicular to a longitudinal axis of the robotic limb than the adjacent interconnected chambers in the inflated configuration.

### RELATED APPLICATIONS

This Application claims the benefit of priority under 35 U.S.C. § 119(e) of U.S. Provisional Application Ser. No. 63/493,386, filed Mar. 31, 2023, the disclosure of which is incorporated herein by reference in its entirety.

### FIELD

Disclosed embodiments are related to articulable inverting and everting robotic limbs.

### BACKGROUND

Gently holding, lifting, and transferring the entire human body with a robotic system remains a challenging problem, despite extensive research and development efforts. Humans are heavy, delicate, deformable, and vary widely in shape and pose. Standard robotic manipulators and end effectors cannot achieve sufficiently gentle human interaction while applying the high forces beneficial to lift the body effectively, although many high impact tasks depend on this functionality. In eldercare and care of people with physical disabilities, lifting humans is a task regularly carried out by caregivers, which is both strenuous and fatiguing on their bodies. This task is also carried out for emergency medical response, search and rescue, occupational therapy, ergonomic support for manual labor, and so forth. The current standard practice in eldercare is for caregivers to manually attach a harness to the patient or wrap their body with straps to securely harness and lift them. Straps are used because they are practical for high-force human interaction. They can be wrapped around any human in nearly any harnessing configuration to distribute the high load over a large contact area. This is enabled primarily by their simultaneously high tensile strength and bending flexibility. However, manual handling by a human is needed to attach straps in the appropriate configurations, which is a major bottleneck preventing fully autonomous human lifting and transferring with robotic systems. Safely harnessing and lifting humans for transfer is a challenging problem for robotics because of the high forces and gentle interaction desired during such tasks. Most harnessing and lifting tasks start with the human sitting or lying down on a resting surface (e.g. a bed). Current devices are unable to slide between the human body and resting surface contact, and thus cannot harness them in those positions. This is due to the lack of space between the body and resting surface and the harmful friction between the body and structure that would occur if it were passed through the gap. Therefore, inserting typical flexible robotic limbs would still need manual manipulation of the patient where the nurse or patient creates a space between the patient and the resting surface in order to position the flexible robotic limb in the space.

### SUMMARY

In some embodiments, a flexible inflatable structure is configured to form a plurality of interconnected chambers arranged in series when inflated, where a maximum transverse dimension of one or more connections between adjacent interconnected chambers of the plurality of interconnected chambers is less than a maximum transverse dimension of the adjacent interconnected chambers when the flexible inflatable structure is inflated. A tether is configured to bias a distal end portion of the inflatable structure to a collapsed configuration.

In some embodiments, a method for operating a flexible robotic limb includes: inflating a flexible structure, where the inflatable structure includes a plurality of interconnected chambers arranged in series, and where a maximum transverse dimension of one or more connections between adjacent interconnected chambers of the plurality of interconnected chambers is less than a maximum transverse dimension of the adjacent interconnected chambers when the flexible inflatable structure is inflated. The method also includes applying a proximally directed force to a distal end portion of the inflatable structure using a tether.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 illustrates a robotic system according to one embodiment;

FIG. 2A shows a perspective view of a flexible robotic limb according to one embodiment;

FIG. 2B shows a front view of a flexible robotic limb according to one embodiment;

FIG. 3A illustrates an unarticulated flexible robotic limb;

FIG. 3B illustrates a flexible robotic limb in an articulated configuration when an actuator is actuated; and

FIGS. 4A-4D illustrate the flexible robotic limb as it is everted.

### DETAILED DESCRIPTION

The inventors have recognized that a flexible robotic limb which everts from the distal end reduces friction as it grows through a gap between two objects (e.g., a subject's body and a supporting surface) due to the process adding material at its tip instead of from its base. However, such flexible robotic limbs, which are sometimes known as vine robotic limbs, are not easily articulated to a desired pose. Specifically, the Inventors have recognized that the constant diameter inflatable structure used to form these flexible robotic limbs lack defined articulation locations and associated actuators for manipulating the pose of these flexible robotic limbs. This limit the ability to control the pose of these flexible robotic limbs relative to an object being manipulated.

In view of the above, the Inventors have recognized the benefit associated with a flexible robotic limb that includes an everting flexible inflatable structure with predefined locations for articulation disposed along the length of an everted portion of the limb. In some instances, these predefined articulation locations may correspond to locations along the everting portion of the robotic limb with a reduced traverse cross sectional area as compared to adjacent portions of the flexible inflatable structure. This may result in an everted portion of the flexible inflatable structure including an interconnected set of chambers arranged in series along a length of the flexible robotic limb. A maximum transverse dimension the connections between these adjacent interconnected chambers may be less than a maximum transverse dimension of the adjacent interconnected chambers. These necked down portions of the everted portion of the flexible inflatable structure may exhibit a reduced bending stiffness. Correspondingly, the resulting flexible robotic limb may show an increased ability to bend and articulate in one, or in some instances multiple, directions as compared to a similar flexible robotic limb without such predefined articulation locations.

The connections fluidly coupling and physically connecting the interconnected chambers may be provided with a reduced cross section using any appropriate construction. In one embodiment, an external constriction (O-ring, rigid ring, or other physical constriction) may be placed around and axially fixed in place along a length of the inflatable structure (e.g., adhesive, physical attachment, welding, friction, etc.). Alternatively, adjacent portions of the flexible inflatable structure may be bonded around its external perimeter to reduce a length of the perimeter (e.g., welds, adhesives, stitching, and/or any other appropriate method for attaching material) to form the necked down connection with a reduced transverse cross sectional area. In yet another embodiment, the flexible inflatable structure may be plasticly molded to exhibit the desired shapes of the chambers and connections. Thus, it should be understood that the disclosed embodiments are not limited to any particular manufacturing method or construction.

To enable articulation of the flexible robotic limb, one or more actuators may be used in combination with the predetermined articulation locations which may also be referred to as joints. The articulation actuators may be individually actuatable or may be configured to actuate in groups or sets depending on the specific application of the flexible robotic limb. Each articulation actuator may be axially fixed to two or more adjacent interconnected chambers and may be configured to control a length between the attachment locations on the adjacent interconnected chambers to control articulation of the associated joint between these chambers. Additionally, in some instances, it may be desirable to articulate in different directions. In such cases, multiple articulation actuators may be distributed around a cross sectional perimeter of the flexible robotic limb. These concepts may be combined. For example, in some embodiments, multiple sets of separate actuators associated with separate joints along a length of the everted flexible inflatable structure and disposed at different locations around a cross sectional perimeter may permit the flexible robotic limb to articulate in multiple different directions along its length. Additionally, in some embodiments, providing three sets of actuators at three spaced apart locations, which may be equidistant spaced apart locations, around a perimeter transverse to a longitudinal axis of the robotic limb in the inflated configuration may permit articulation in a number of different directions including, for example, articulation in any direction in 360° around a longitudinal axis passing through the connection between adjacent chambers.

The one or more articulation actuators may be any appropriate type of actuator that when actuated, decreases a distance between opposing portions attached to adjacent interconnected chambers. In some embodiments, an articulation actuator may maintain a desired length and resists both compression and extension of the actuator between the attachments to adjacent interconnected chambers. Appropriate articulation actuators may include, but are not limited to, pneumatic and/or hydraulic bladders (e.g., Mckibben artificial muscles), shape memory actuators, Kirigami actuators, electroactive polymer actuators, and/or any other appropriate actuator.

In some embodiments, a tether is included in a flexible robotic limb which is configured to control the inversion and eversion of a flexible inflatable structure. This tether is connected to the distal tip of the inflatable structure and may control a length of the everted portion of the inflatable structure. For example, a length of the tether may be increased or decreased to control the length of the everted portion of the inflatable structure. The tether may correspond to any appropriate structure including, but not limited to: an interior portion of the inflatable structure located proximal to the distal tip of the flexible inflatable structure; a wire; a cable; a strap; combinations of the forgoing; and/or any other appropriate flexible connection capable of being attached to and applying a force to a distal tip of the inflatable structure to control a length of the everted portion of the flexible inflatable structure.

In the various embodiments disclosed herein, a flexible inflatable structure may have an approximately tube-like shape and may exhibit sufficient flexibility such that the flexible inflatable structure may invert into and evert out of a distal tip of the flexible inflatable structure. Additionally, the flexible inflatable structure may be constructed from any sufficiently flexible material (e.g., a sheet like material) that is sufficiently impermeable to permit inversion/eversion of the structure while also maintaining a desired pressure within a pressurized interior volume of the flexible robotic limb when a pressurized fluid (gas or liquid) is supplied. Additionally, the arm may be axially and radially inextensible which further strengthens the arm. Appropriate types of materials include, but are not limited to, polymeric membranes, fabrics, composite membranes, combinations of the forgoing, and/or any other appropriate material. In some embodiments, reinforcing continuous high-strength fibers may also be embedded into the membrane or other material material of the interconnected chambers in a longitudinal direction of the robotic limb to provide enhanced tensile strength.

This disclosed flexible robotic limbs may exhibit a number of benefits. For example, such a design may enable the flexible robotic limb to extend without supporting environmental contacts to high lengths without decreasing the maximum active curvatures, in that the higher compressive stiffness prevents it from collapsing under the weight of its extended body while the lower bending stiffness allows the actuators to bend the flexible robotic limb to greater curvatures. This may be desirable for tasks such as harnessing and lifting humans because of the long lengths that these “strap-like” structures may extend to without supportive environmental contacts. This also be desirable in open-loop cantilevered configurations while articulating around the human, before possibly mounting the tip and closing the loop to harness the flexible robotic limbs. Although the disclosed flexible robotic limbs may be used to assist in lifting patients through low friction eversion, they may be used for any appropriate application and may be used with a variety of different end effectors disposed on a distal end portion of the robotic limb which may allow the disclosed systems to be used for multiple purposes. Appropriate types of end effectors may include, but are not limited to a force sensor, a manipulator, a gripper, a cutting tool, a magnet, or a camera.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

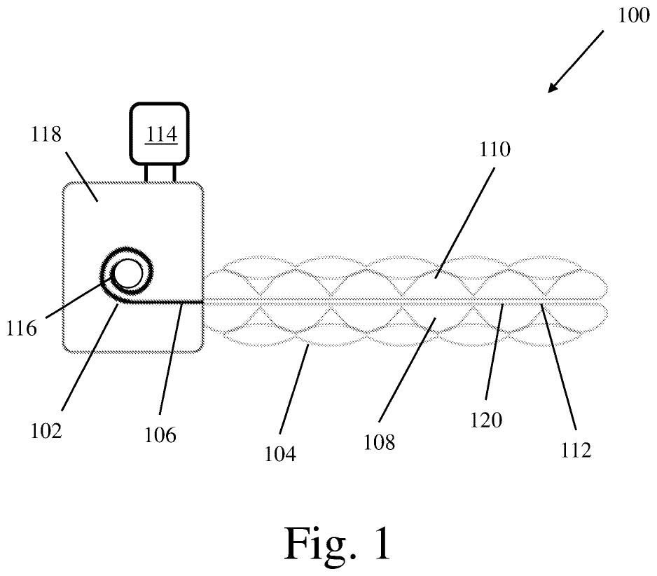

FIG. 1 illustrates one embodiment of a flexible robotic limb 100. An everted portion of a flexible inflatable structure 110 extends out from a housing 118. In an extended state, the flexible inflatable structure 110 includes a plurality of serially arranged interconnected chambers 108. Connections 112 may be disposed between adjacent chambers. An inverted portion 120 of the flexible inflatable structure may extend inwards from a distal everted tip of the flexible inflatable structure 110 and pass through an interior of the everted portion of the flexible inflatable structure 110. One or more sets of articulation actuators 104 may be disposed along a length of the everted portion of the flexible inflatable structure 110. In some embodiments, each articulation actuator 104 may be axially fixed to two or more interconnected chambers 108, and in some instances, to each interconnected chamber 108 along a length of that specific actuator 104. In the depicted embodiment, two separate sets of articulation actuators 104 are disposed on opposing sides of the flexible robotic limb 100 to enable articulation in two opposing directions.

As discussed previously above, the everted portion of the flexible robotic limb may include one or more predetermined joints. Specifically, as shown in the figure, the connections 112 between adjacent interconnected chambers 108 have a smaller transverse cross-sectional area than the adjacent interconnected chambers 108. Thus, the connections may function as living hinges with a reduced bending stiffness as compared to the adjacent interconnected chambers 108. It should be understood that the interconnected chambers 108 may exhibit any appropriate shape including, but not limited to spherical, tear drop, ovoidal, and/or any other appropriate shape. In some embodiments, the interconnected chambers 108 may have shapes that longitudinal taper inwards towards an associated connection. An end portion of the everted portion of the flexible inflatable structure 110 may be sealed to the housing 118 to form a sealed volume therewith. A pressure source 114, such as a pump, pressurized house air, gas cylinders, and/or any other appropriate source of pressurized fluid may be fluidly coupled to the sealed internal volume of the housing 118. Thus, the pressure source, 114 may pressurize the flexible inflatable structure 110 which biases the flexible inflatable structure towards a fully everted configuration. A tether 106 may be coupled to, or be formed by, the inverted portion 120 of the flexible inflatable structure 110. A length of the tether may be controlled using a winch 116 or any other appropriate actuator capable of extending or retracting the tether. Correspondingly, when pressurized, controlling a length of the tether may control a length of the everted portion of the flexible inflatable structure 110 extending out from the housing 118.

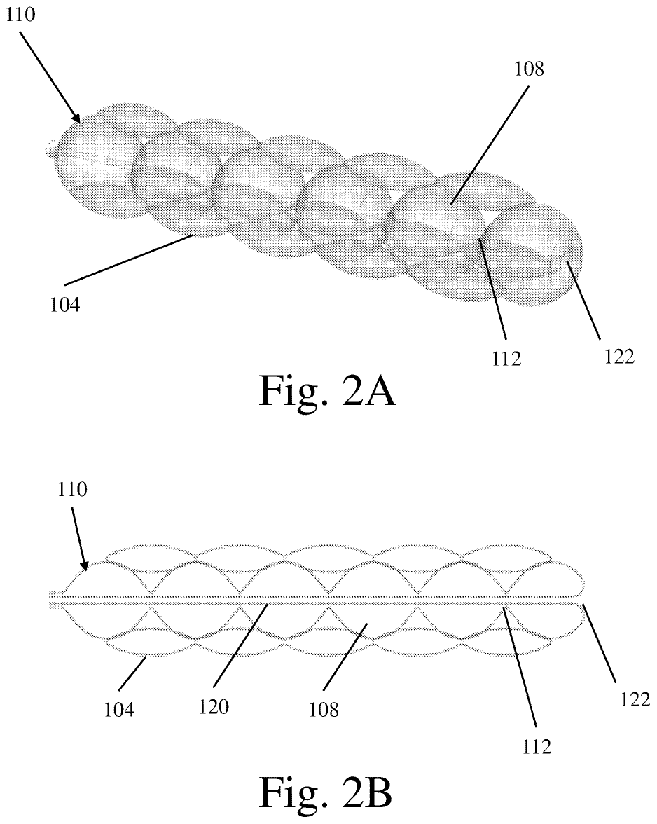

FIGS. 2A and 2B show different views of the flexible inflatable structure 110 and the associated articulation actuators 104 in more detail. portion of the flexible robotic limb 110. The features of the flexible robotic limb such as the interconnected chambers 108, the connections 112 between adjacent chambers 108, the inverted portion 120 of the flexible inflatable structure 110 extending through an interior of the outer everted portion of the flexible inflatable structure 110, and the articulation actuators 104 can clearly be seen. Again, the connections 112 between adjacent interconnected chambers 108 of the flexible inflatable structure 110 has a smaller transverse cross-sectional area than the adjacent interconnected chambers 108 when inflated. The interconnected chamber connection geometry allows for increased curvatures and bending of the flexible robotic limb while also maintaining a relatively high compressive stiffness. As also seen in the figures, a distal indentation is formed in a distal end portion of the everted flexible inflatable structure 110 due to the tether, not depicted, applying a proximally directed force to the inverted portion 120 of the flexible inflatable structure 110. Depending on the desired load and operation of the flexible robotic limb the applied tensile force and pressure may be increased or decreased to vary a compressive stiffness of the flexible robotic limb.

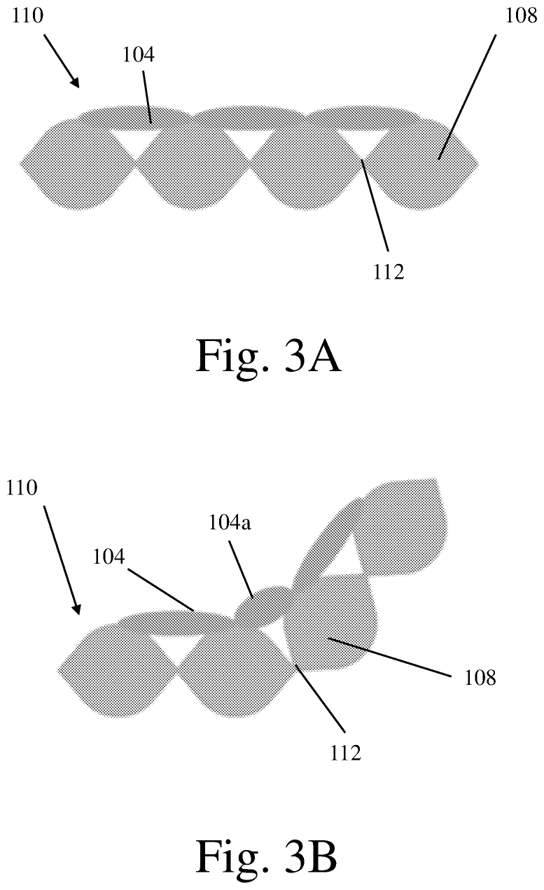

FIGS. 3A and 3B depict the flexible robotic limb in both an unarticulated (i.e., straight or unbiased configuration) and an articulated configuration where one or more portions of the flexible robotic limbs are angled relative to the straight or unbiased configuration. In FIG. 3A all articulation actuators 104 are in a relaxed state such that the connections between the ends of each actuator and the associated adjacent interconnected chambers 108 are unbiased and the flexible robotic limb 110 is generally straight. In FIG. 3B the center actuator 104a is actuated, which shortens the distance between the opposing ends of the actuator 104a and the axially affixed potions of interconnected chambers 108. With the length shortened, the attached portions of the adjacent interconnected chambers 108 are pulled towards each other and the connection 112 bends to allow for this articulation. Of course, while actuation of a single actuator has been illustrated, the actuation of multiple actuators associated with multiple separate pairs of adjacent interconnected chambers are also contemplated.

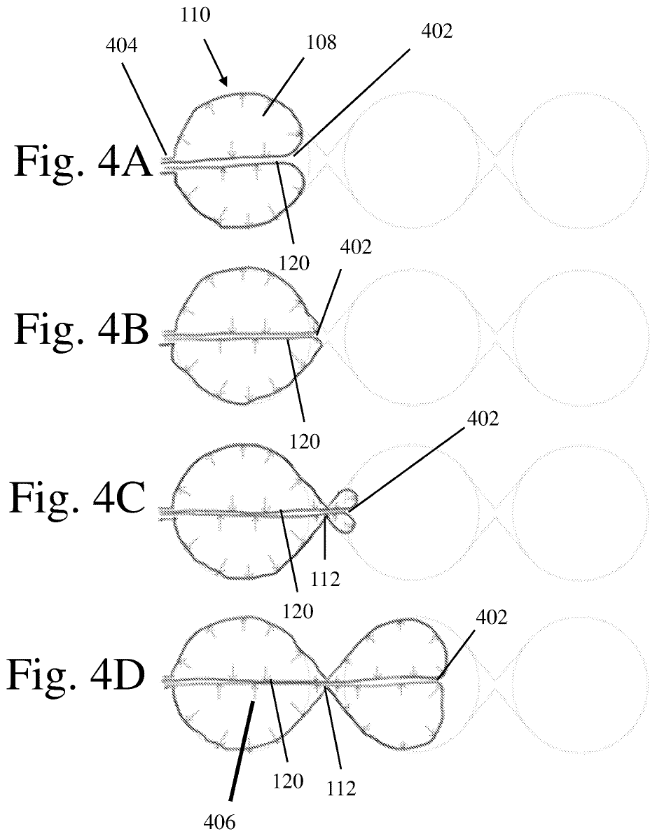

FIGS. 4A-4D depict one embodiment of a process in which a flexible inflatable structure 110 everts. The inverted portion 120 of the flexible inflatable structure 110 expands through the distal tip 402 while maintaining the structure of the interconnected chamber connectors 112. During inflation, the pressure within the flexible robotic limb causes the inverted portion 120 to remain compact and located within a central portion of the interior of the flexible inflatable structure 110. While the flexible inflatable structure 110 is pressurized and as a length of an associated tether is increased, the interior portion 120 of the flexible inflatable structure 110 is fed in a distal direction such that it everts through the distal tip 402 such that it becomes part of the everted portion of the flexible inflatable structure 110 located on an exterior of the flexible inflatable structure 110. Thus, both the connections 112 and the serially arranged interconnected chambers 108 may be fed through the distal tip 402. Of course, the inverse process where a tether length is shortened and a distal portion of the everted flexible inflatable structure 110 is inverted into the interior of the flexible inflatable structure 110 may also be performed.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A flexible robotic limb comprising:
a flexible inflatable structure configured to form a plurality of interconnected chambers arranged in series when inflated, wherein a maximum transverse dimension of one or more connections between adjacent interconnected chambers of the plurality of interconnected chambers is less than a maximum transverse dimension of the adjacent interconnected chambers when the flexible inflatable structure is inflated; and
a tether configured to bias a distal end portion of the inflatable structure to a collapsed configuration.

2. The flexible robotic limb of claim 1, wherein an extended length of the tether controls a length of an everted portion of the flexible inflatable structure.

3. The flexible robotic limb of claim 1, wherein the tether includes a wire, a cable, a strap, and/or an inverted portion of the flexible inflatable structure extending through an interior of the flexible inflatable structure.

4. The flexible robotic limb of claim 1, further comprising an actuator configured to control an extended length of the tether.

5. The flexible robotic limb of claim 1, further comprising at least one actuator extending between and axially fixed along its length to one or more pairs of adjacent interconnected chambers of the flexible inflatable structure, wherein the actuator is configured to control a length between the one or more pairs of adjacent interconnected chambers.

6. The flexible robotic limb of claim 1, wherein the at least one actuator includes an actuator that extends along a length of an everted portion of the flexible inflatable structure and is axially fixed along its length to a plurality of pairs of adjacent interconnected chambers, and wherein the actuator is configured to control a length between each pair of the plurality of pairs of adjacent interconnected chambers.

7. The flexible robotic limb of claim 1, wherein the at least one actuator is a plurality of actuators disposed along a length and/or perimeter of the everted portion of the flexible inflatable structure.

8. The flexible robotic limb of claim 5, wherein the at least one actuator comprises at least one of a pneumatic bladder, a hydraulic bladder, a shape memory actuator, a Kirigami actuator, and an electroactive polymer actuator.

9. The flexible robotic limb of claim 1, wherein the flexible inflatable structure comprises a flexible tube.

10. The flexible robotic limb of claim 8, wherein the flexible inflatable structure resists axial and radial expansion.

11. A method for operating a flexible robotic limb comprising:
inflating a flexible structure, wherein the inflatable structure includes a plurality of interconnected chambers arranged in series, wherein a maximum transverse dimension of one or more connections between adjacent interconnected chambers of the plurality of interconnected chambers is less than a maximum transverse dimension of the adjacent interconnected chambers when the flexible inflatable structure is inflated; and
applying a proximally directed force to a distal end portion of the inflatable structure using a tether.

12. The method for operating the flexible robotic limb of claim 11, controlling an extended length of the tether to control a length of an everted portion of the flexible inflatable structure.

13. The method for operating the flexible robotic limb of claim 12, controlling the extended length of the tether with an actuator.

14. The method for operating the flexible robotic limb of claim 11, wherein the tether includes a wire, a cable, a strap, and/or an inverted portion of the flexible inflatable structure extending through an interior of the flexible inflatable structure.

15. The method for operating the flexible robotic limb of claim 11, controlling a length between one or more pairs of adjacent interconnected chambers with at least one actuator.

16. The method for operating the flexible robotic limb of claim 11, controlling a length between multiple pairs of adjacent interconnected chambers with at least one actuator.

17. The method for operating the flexible robotic limb of claim 11, wherein the at least one actuator is a plurality of actuators disposed along a length and/or perimeter of an everted portion of the flexible inflatable structure.

18. The method for operating the flexible robotic limb of claim 15 wherein the at least one actuator comprises at least one of a pneumatic bladder, a hydraulic bladder, a shape memory actuator, a Kirigami actuator, and an electroactive polymer actuator.

19. The method for operating the flexible robotic limb of claim 11, wherein the flexible inflatable structure comprises a flexible tube.

20. The method for operating the flexible robotic limb of claim 19, wherein the flexible inflatable structure resists axial and radial expansion.
